(19) United States
(12) Patent Application Publication
(10) Pub. No.: US 2011/0244442 A1
(43) Pub. Date: Oct. 6, 2011

(54) VIDEO WHITEBOARD APPARATUS AND METHOD

(75) Inventors: Robin Sheeley, Maple Plain, MN (US); William Graham, Minnetrista, MN (US)

(73) Assignee: VADDIO, LLC, New Hope, MN (US)

(21) Appl. No.: 13/053,383

(22) Filed: Mar. 22, 2011

Related U.S. Application Data
(60) Provisional application No. 61/341,468, filed on Mar. 31, 2010.

(51) Int. Cl. B43L 1/00; H04N 9/64; H04N 9/67

(52) U.S. Cl. 434/408; 348/720; 348/659; 348/E09.037; 348/E09.047

(57) ABSTRACT

Embodiments of the present invention include an apparatus and method for capturing marker or pen strokes on a whiteboard, and creating output video signal that shows how the contents of the whiteboard changes over time during a lecture or presentation. A conventional whiteboard surface is used. Conventional whiteboard tools, such markers, are fit with holders or adapters to allow their state (e.g., marker color, marker up, marker down, marker position) to be sensed as human interface device (HID) events. Other parameters affecting how the output video may be entered through a whiteboard user interface. HID events are converted into video output signal by a whiteboard video generator, using the HID events to maintain an up-to-date representation of the cumulative state of the whiteboard surface. This cumulative state is regularly transmitted as digital and/or analog signal to output ports. At any time, a snapshot of the current state of the whiteboard can be saved by a user to an external storage device, such as a flash drive, as an image (e.g., JPEG) file. The whiteboard video generator is preferably an appliance that is dedicated to the task of maintaining the cumulative state of the whiteboard surface, creating video, and storing snapshots on demand.

### CROSS REFERENCE TO RELATED APPLICATION

This application claims the benefit of U.S. Provisional Application No. 61/341,468, filed Mar. 31, 2010, and is hereby incorporated by reference herein.

### FIELD OF THE INVENTION

The present invention relates to a method and apparatus for capturing a presentation in video form. More specifically, the present invention relates to an apparatus and method for creating a video signal from a presentation made with conventional drawing tools on a conventional whiteboard surface.

### SUMMARY OF THE INVENTION

While conducting a lecture, seminar, or other presentation, a presenter will commonly write or draw on a whiteboard (WB) with a drawing tool, such as a WB marker, or erase such marks with another tool, such as a WB eraser. The drawing tool makes or removes physical marks, such as strokes, sketches, drawings, shaded regions, or characters, drawn with whiteboard marker ink, on the conventional whiteboard drawing surface. A drawing detection manager detects characteristics, state, and/or activities of drawing tools being used on the WB, such as tool type (e.g., marker or eraser), tool color (e.g., green marker), whether or not the drawing tool is in contact with the surface (“marker down” or “marker up,” respectively), and the location of the tip of the marker, as projected onto the surface of the WB. In some embodiments, the drawing detection manager might detect angle that a longitudinal axis of a drawing tool makes with the surface, or rotation of drawing tool about a longitudinal axis. Other characteristics of a drawing tool, such as its state and its activities might also be detected by the detection manager.

The drawing detection manager acts in cooperation with compatible drawing tools in detecting tool state and activity. A drawing tool might be specially designed to cooperate with the drawing detection manager. Alternatively, a conventional drawing tool, such as a whiteboard marker or eraser or a type that might be purchased off-the-shelf from a typical office supply store, might be augmented with an adapter for this purpose. For example, a standard marker might be inserted into a sleeve or holder, such that the point of the marker protrudes for use. In some embodiments, each adapter is configured for a specific tool; for example, a red marker adapter should preferably hold a red marker, and an eraser adapter should hold an eraser. In other embodiments, the adapter might allow such configuration to be set manually through an adapter UI.

A given system might utilize specially designed, and/or adapted conventional drawing tools, in any combination. In either case, we will refer to such a drawing tool as an “adapted drawing tool”; when it is clear from the context, however, that a drawing tool is adapted and participating in the system, the term “drawing tool” or simply “tool,” will suffice to indicate an adapted drawing tool. In general, a drawing tool might be a brush, a pen, a piece of chalk, or any other device that makes or removes a physical mark on the surface.

The drawing detection manager detects information about the state and activity of adapted drawing tools. An adapted drawing tool might include one or more sensors and/or one or more transmitters or receivers. Similarly, the drawing detection manager might include one or more sensors, transmitters, and/or receivers to allow it to perform its function. The function of the drawing detection manager might be centralized within one device, or contained in a plurality of units associated with the WB.

As an example of drawing detection, consider detection of the projection of a marker tip onto the plane of the WB. That, is the x and y position of the marker tip, where z is its position perpendicular to the WB. The adapter might sense its x-y position by sound waves or electromagnetic waves reflected off the WB surface. Or the adapter might sense its x-y position by receiving triangulating on a signal received from sources positioned around the WB. In any of these approaches, the adapter could then transmit its position to the drawing detection manager by sound (e.g., ultrasonic transmission) or by electromagnetic radiation (e.g., infrared). On the other hand, the adapter might transmit one or more signals that would allow the drawing detection manager to calculate x-y position. A transmitter in the detection manager might send a signal, which is received by a receiver in a drawing tool, the signal requesting the adapted tool to itself transmit a signal.

Whether an adapted tool is in contact with the WB surface might be initially detected by a pressure sensor in the adapted tool, for example, within a tool adapter. In this case, the tool might transmit the information to the detection manager. On the other hand, the detection manager might sense tool up/down by detecting z-position in a manner similar to detection of x-y position.

A tool adapter might contain a user interface that provides controls whereby a user can select characteristics of the tool, such as color or tip width. Or any such characteristic might be a static property of the adapter. In either case, the detection manager would typically receive such information by transmission from the adapted tool. Alternatively, any such characteristic, for any tool or set of tools, might be selectable through a user interface on a more centralized WB Controller (WBC).

Obviously, many arrangements for detection of tool state and activities are possible within the scope of the invention. Typically, such detection involves some communication(s) between the adapted drawing tool and the drawing detection manager. In any case, information about tool state and activities is received by the WBC. Preferably, some or all of the functionality of the drawing detection manager is integrated into the WBC.

Over an interval of time, a representation of the cumulative state of the WB surface is maintained in digital form, by a WB video generator (WBVG), as the cumulative state evolves due to actions of the lecturer, such as writing on or erasing the WB. The system might support saving the cumulative state in memory or in a storage device such as a flash drive or hard disk. This evolving cumulative state is output by the WBVG to a video output port (or “jack” or “connector”). The output might be in digital form to a digital output port, such as DVI-D port. The output might be in analog form to an analog output port, such as a YPbPr port or a CVBS port. Some embodiments may have a two or more ports, digital and/or analog in any combination.

The WB surface may fabricated from any type of material used to manufacture conventional whiteboards, such as melamine, painted steel or aluminum, glass or magnetic glass, or hardcoat laminate. Preferably, the WB will employ enamel-on-steel construction. The WB surface is part of a WB assembly, which might include a tray to hold drawing tools. The WBC will typically be attached to the WB. The WBC might consist of one or more devices, which might be attached to the WB frame or hidden within the tray. The WBC receives drawing tool events from the detection manager, which might or might not be integrated into the WBC itself. The WBC, in turn, transmits these events to the WBVG, typically in the form of human interface device (HID) records or events. Different drawing tools may send different kinds of HID events; for example, a spray gun will send some HID events that differ in kind or functionality from others sent by, say, an eraser. The WBC may also have a WB user interface (WBUI) that contains one or more user controls. These controls might be hardware controls (e.g., buttons or switches) or graphical user interface controls, or some combination of both.

For example, the WBUI might include controls to set the width of the marker displayed in the video output. The WBUI might include a “calibrate” control, which would cause the WBC to determine an aspect of the geometry of the WB, such as the locations of its boundaries, its spatial position, or its spatial orientation. The calibrate control might also serve to turn the system on. The WBUI might include a “clear” control, to command the WBVG to erase or clear the representation of the cumulative state of the WB surface. The WBUI might include a “save” control, to command the WBVG to store the representation of the cumulative state of the WB surface onto a storage device, such as an external or internal disk drive, or an external flash drive.

Systems comprising a WBUI, WBC, and compatible drawing tool adapters are available commercially. For example, Luidia, Inc. provides EBEAM® technology for this purpose. However, interpretation of the appropriate response to WBUI controls of an EBEAM® system will typically be done by the WBVG. For example, a WBUI might contain several buttons. When the top button is pressed by a user, the WBUI might send a signal to that effect. Interpreting that signal as a “clear” command or as a “save” command, and responding accordingly, will ordinarily be a job for the WBVG

The WBVG may be housed separately from the WB Assembly, or might be combined with the WB Assembly. Preferably, in either case, the WBVG will be an “appliance.” That is, the WBVG will be dedicated to the task of receiving WB events from the WBC, converting them on an ongoing basis to current representations of the cumulative state of the WB surface, and transmitting those representations to a video output signal(s); in some embodiments the WBVG might also, on command, save the current representation of cumulative state to a storage device, such as an external flash drive. Such a dedicated appliance might provide access for firmware or software updates, for diagnostics, and/or for setting various operational parameters. Preferably, however, the WBVG will not be attached to a keyboard, or permit control by a conventional USB device such as a mouse or joystick. The WBVG may be connected to a monitor, for example, to display a video output signal. In some embodiments, the WBVG is housed within the WB Assembly, for example, within a drawing tool tray. In such cases, the functionality of the WBVG and the WBC might be combined into a single unit or board.

The principal function of the WBVG is to receive HID events from the WBC, and convert them into one or more output video signals. These output video signals are dynamic in the sense that they portray in near real time how the surface of the WB is being modified by the presenter. Typically, the WBVG will request that the WBC send a single HID event from a buffer maintained by the WBC; in effect, the WBVG pulls HID events from the WBC. Sequences of HID events are converted by a general purpose processor in the WBVG into vector form. For example, the sequence of HID events—blue marker down, blue marker movement through a series of positions, and blue marker up—will be converted into a vector event as a blue marker stroke. The WBVG maintains a representation of the cumulative state of the drawing surface, since a last erase command, or since the system was powered on. This representation will preferably be in raster form, but a vector form might be saved instead, or in addition. When a vector event becomes available, a representation of cumulative state will be updated accordingly. If a cumulative representation is maintained in raster form, a new vector event will be converted to raster before the representation of cumulative state is updated. The representation of cumulative state can then be sent as a frame of an output digital video signal to a digital output port. The output digital signal might be converted by a digital-to-analog converter, such as a digital signal processor (DSP), within the WBVG, and then transmitted to an analog video output port. The video output will continue to be generated, in near real time, as the presenter uses the WB, the cumulative state as shown in the video output evolving in near real time.

To accomplish its tasks, the WB Video Generator may contain a general purpose processor, a digital signal processor (DSP), memory, storage, an input port that receives information from the WB Controller, and one or more output ports for providing video output signal in one or more formats. Analog output may include HD15 YPbPr and composite (CVBS) video. Digital output may include high definition Digital Video Interface (DVI-D) video. The general purpose processor may run a version of the Linux operating system, or some other operating system such as a version of Google Chrome or Microsoft WINDOWS®. The general purpose processor and the DSP may be combined into a single processing unit, or they may be separate. Software instructions may be stored on any kind of tangible storage device within the WBVG, including memory, flash memory, hard disk, or solid state disk.

The WBVG may also contain a USB port to connect an external storage device, such as a hard drive or flash drive, to the WB Video Generator, so that a screen snapshot (formed by accumulating WB events since some specific last WBUI event, such as a erase, or power on of the WBUI) or a video recording of the WB drawing activities can be saved in a place accessible to a user.

Typically, the WBVG will be a closed, self-contained, dedicated appliance. It will not have a keyboard or monitor, or allow external input from HID devices, such as mice, other than the WB Controller. The WB Video Generator may include a serial port or an Ethernet port to allow firmware upgrades and for running diagnostics. The WBVG may contain dip switches to control aspects of its operation.

A WB video output stream, representing the drawing that is being done on the whiteboard, from the WB Video Converter might be combined with one or more other video sources to produce a composite output. Another video source might be a static image, such a set of grid cells or a map. Or another video source might be another dynamic video signal, such as weather radar or a sporting event. The combined output will typically superpose video output from the WBVG on top of the other video source(s).

One example of a combined video stream is a picture-in-picture combined video. In such combined streams, the video output (which is typically, but not necessarily, rectangular in shape) is divided into a plurality of regions, with each region displaying a different video signal. For example, suppose that a lecturer is writing on a WB. Inset into the combined output might be the output of a camera recording the lecturer who is drawing on the WB. Thus, the combined output might mainly show what is being drawn, unobstructed by the lecturer. But the inset could show the lecturer, to capture facial expressions, arm gestures, and so forth. Alternatively, the view of the lecturer might occupy the bulk of an output rectangle, with the output from the WBVG shown inset. Many other layouts and sources, are of course possible. The video recorded by the camera might also show other information that is projected by a projection system onto the WB.

Typically, such mixing will be done by a video mixer, which provides the combined output, normally through a standard connector or jack. The video mixer might be a device separate from the WBVG, or the functionality of both might be housed in a single unit. The output might be analog, digital, or both.

In some embodiments, the WBC behaves as USB slave device, and provides a cable, terminating in a USB male connector, to output HID events. Hidden within the frame and/or drawing tool tray of the WB is a CAT5 extension cable, to which the WBC's USB male connector is connected. The CAT5 extension cable terminates in a CAT5 female connector on the surface of the WB frame or tray. A CAT5 cable can be connected between the WBC's CAT5 female connector to a similar arrangement in the WBVG. The use of CAT5 cable as an intermediary, to carry USB signal from the WB Assembly to the WBVG, allows the WBVG to be located further from the WBC than would be feasible using a USB cable directly.

### BRIEF DESCRIPTION OF THE DRAWINGS

FIG. 1 is a schematic diagram of a system, including a Whiteboard Assembly and a Whiteboard Video Generator.

FIG. 2 is a perspective drawing of a WB Assembly.

FIG. 3 shows a side view of a whiteboard marker drawing tool.

FIG. 4 is a flowchart showing a method for generating video signal from drawing tool events on the WB surface.

FIG. 5 is a flowchart showing a more detailed method for generating video signal from drawing tool events on the WB surface.

FIG. 6 is a flowchart showing a method for storing a snapshot of the current representation of the cumulative drawing surface state.

FIG. 7 is a schematic diagram of a simple system, showing information flows.

FIG. 8 is a front view of a WB Video Generator.

FIG. 9 is a rear view of a WB Video Generator.

FIG. 10 illustrates a detailed schematic diagram of a system, including a WB Assembly and a WB Video Generator.

FIG. 11 is a schematic diagram of a system producing combined video output, showing information flows.

FIG. 12 is a drawing illustrating a layout of combined video output for picture-in-picture combined video output.

FIG. 13 is a cross-section of a WB drawing tool tray, showing an embedded WB Video Generator.

### DETAILED DESCRIPTION OF EXEMPLARY EMBODIMENTS

This section and the accompanying figures describe exemplary embodiments of the invention. They should not be taken to limit the scope of the invention, which can have many alternative embodiments.

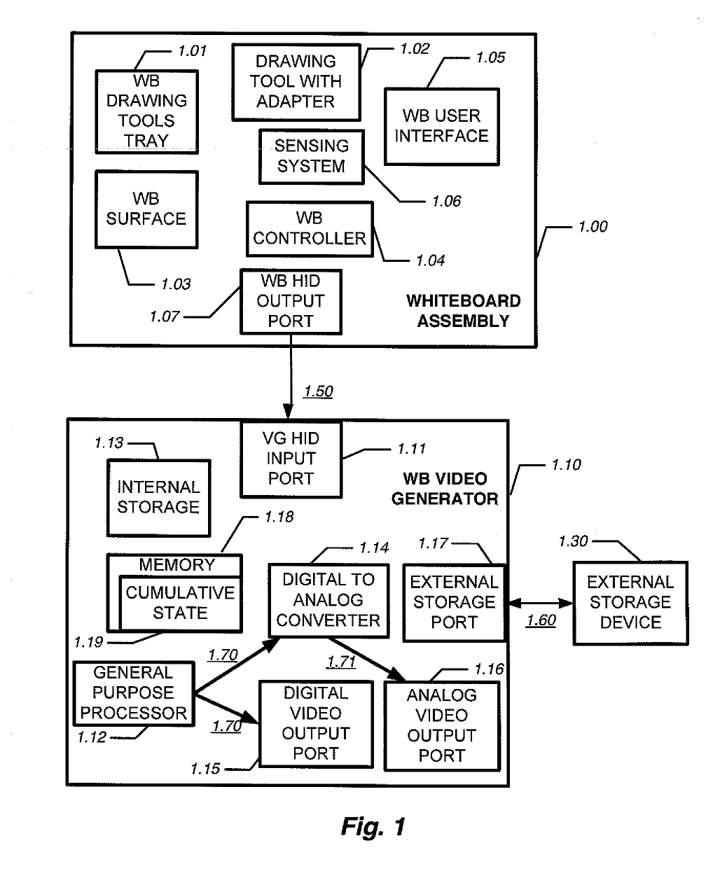

FIG. 1 depicts an embodiment of a system illustrating some of the inventive concepts. The system includes a Whiteboard (WB) Assembly 1.00, and a WB Video Generator (WBVG) 1.10. The WB Assembly 1.00 includes a WB surface 1.03. The WB surface 1.03 may be fabricated from any type of material used to manufacture conventional WBs, such as melamine, painted steel or aluminum, glass or magnetic glass, or hardcoat laminate. Preferably, the WB surface 1.03 will employ enamel-on-steel construction. The WB Assembly 1.00 includes one or more adapted drawing tools 1.02, each of which could be of any type that either makes a physical mark on the WB surface 1.03, or removes such a mark. The WB Assembly 1.00 includes a drawing detection manager 1.06, which detects various aspects of the state and activities of the adapted drawing tools 1.02. For a whiteboard marker, such information might include the color of the marker, whether the marker is in contact with the WB surface 1.03 (down) or not (up); the projection of the position of the tip onto the plane of the WB surface 1.03, the angle of a longitudinal axis of the tool 1.02 relative to the WB surface 1.03, and an angle of rotation of the tool 1.02 about the longitudinal axis. Different kinds of adapted drawing tools 1.02 (e.g., a paint brush) may have specific properties, all of which might be sensed by the drawing detection manager 1.06.

The drawing detection manager 1.06 detects information about the state and activity of adapted drawing tools 1.02. An adapted drawing tool 1.02 might include one or more sensors and/or one or more transmitters or receivers. Similarly, the drawing detection manager 1.06 might itself include one or more sensors, transmitters, and/or receivers to allow it to perform its function. The function of the drawing detection manager 1.06 might be centralized within one device, or contained in a plurality of units associated with the WB.

As an example of drawing detection, consider detection of the projection of a marker tip onto the plane of the WB surface 1.03. That, is the x and y position of the marker tip, where z is its position perpendicular to the WB. The adapter might sense its x-y position by sound waves or electromagnetic waves reflected off the WB surface 1.03. Or the adapter might sense its x-y position by receiving triangulating on a signal received from sources positioned around the WB. In any of these approaches, the adapter could then transmit its position to the drawing detection manager 1.06 by sound (e.g., ultrasonic transmission) or by electromagnetic radiation (e.g., infrared). On the other hand, the adapter might transmit one or more signals that would allow the drawing detection manager 1.06 to calculate x-y position. A transmitter in the drawing detection manager 1.06 might send a signal, which is received by a receiver in an adapted drawing tool 1.02, the signal requesting the adapted tool to itself transmit a signal.

Whether an adapted drawing tool 1.02 is in contact with the WB surface 1.03 might be initially detected by a pressure sensor in the adapted drawing tool 1.02, for example, within a tool adapter. In this case, the tool 1.02 might transmit the information to the drawing detection manager 1.06. On the other hand, the drawing detection manager 1.06 might sense tool up/down by detecting z-position in a manner similar to detection of x-y position.

A tool adapter might contain a user interface that provides controls whereby a user can select characteristics of the tool 1.02, such as color or tip width. Or any such characteristic might be a static property of the adapter. In either case, the drawing detection manager 1.06 would typically receive such information by transmission from the adapted drawing tool 1.02. Alternatively, any such characteristic, for any tool 1.02 or set of tools 1.02, might be selectable through a user interface on a more centralized WB controller (WBC) 1.04.

Obviously, many arrangements for detection of tool state and activities are possible within the scope of the invention. Typically, such detection involves some communication(s) between the adapted drawing tool 1.02 and the drawing detection manager 1.06. In any case, information about tool state and activities is received by the WBC 1.04 through the drawing detection manager 1.06.

The WB Assembly 1.00 includes a WB drawing tools tray 1.01 to hold adapted drawing tools 1.02. The WB Assembly 1.00 includes the WBC 1.04, which receives information about drawing events from the drawing detection manager 1.06. Some or all of the functionality of the drawing detection manager 1.06 will preferably be integrated into the WBC 1.04. Some of the functionality of the drawing detection manager 1.06 might be performed by other units within the WB Assembly 1.00. Systems comprising a WBUI 1.05, WBC 1.04 having an integrated drawing detection manager 1.06, and compatible drawing tool adapters are available commercially. For example, Luidia, Inc. provides EBEAM® technology for this purpose. The attributes sensed by the WBC 1.04 are transmitted by the WBC 1.04 as human interface device (HID) events through a WB HID Output Port 1.07.

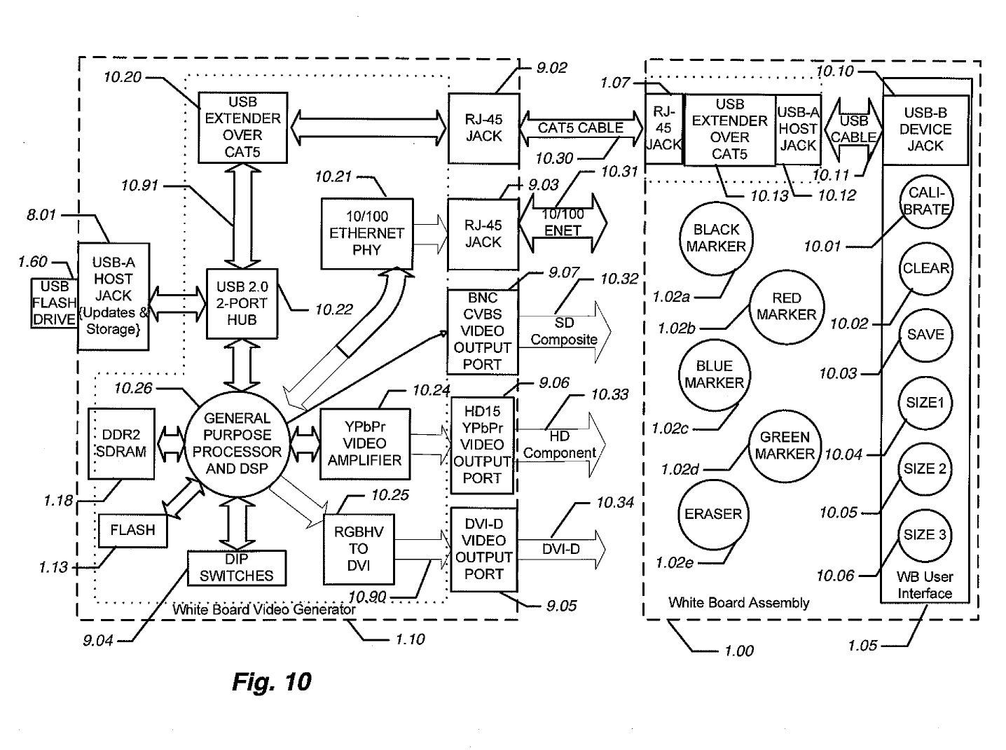

The WB Assembly 1.00 also has a WBUI 1.05 to allow a user to interact with the system. The WBUI 1.05 contains one or more user controls. These controls might be hardware controls (e.g., buttons or switches) or graphical user interface controls, or some combination of both. Example controls will be discussed in more detail in connection with FIG. 10.

The WBVG 1.10 in the embodiment shown in FIG. 1 contains two processors, a general purpose processor 1.12 and a digital-to-analog converter 1.14, typically a digital signal processor (DSP) 1.14. In some embodiments, these two processors may be combined into a single processing unit, while in others they may be separate. The WBVG 1.10 includes memory 1.18 that is used by the processors to hold software instructions and data. Software programs and data may be contained in internal storage 1.13, which might be of any type, such as flash memory, hard disk, solid state disk. The software programs and data are read into memory as needed. The general purpose processor 1.12 runs an operating system, such as the Linux operating system, the Google Chrome operating system, the WINDOWS® operating system, or another operating system.

The WBVG 1.10 may be housed separately from the WB Assembly 1.00, or might be combined with the WB Assembly 1.00. Preferably, in either case, the WBVG 1.10 will be an “appliance.” That is, the WBVG 1.10 will be dedicated to the task of receiving WB events from the WBC, converting them on an ongoing basis to current representations of the cumulative state of the WB surface, and transmitting those representations to a video output signal(s); in some embodiments the WBVG 1.10 might also, on command, save the current representation of cumulative state to internal storage 1.13 or an external storage device 1.30, such as an external flash drive or hard drive. Such a dedicated appliance might also provide access for firmware or software updates, for diagnostics, and/or for setting various operational parameters. Preferably, however, the WBVG 1.10 will not permit control by a conventional user interface device such as a keyboard or a mouse. However, a monitor might be attached to the device, for example to display video output.

The WBVG 1.10 receives HID events from the WB Assembly 1.00 through a WBVG HID input port 1.11, as indicated by arrow 1.50. The principal function of the WBVG is to convert the HID events into one or more output video signals that represent in near real time how the cumulative state 1.19 of the WB surface 1.03 as it evolves in time. Typically, the WBVG will request that the WBC send a single HID event from a buffer maintained by the WBC 1.04; in effect, the WBVG pulls HID events from the WBC. Sequences of HID events are converted by the general purpose processor 1.12 into vector form. For example, the sequence of HID events—marker down, marker movement through a series of positions, and marker up—will be converted into a marker stroke vector event. The WBVG 1.10 maintains the representation of the cumulative state 1.19 of the drawing surface, since a last erase command, or since the system was powered on. The cumulative state 1.19 will ordinarily be maintained only in memory, although in some embodiments it might be maintained in slower storage such as a hard drive. For the sake of performance, the representation of cumulative state 1.19 will preferably be in raster form, but a vector form might be saved instead, or in addition. When a vector event becomes available, any representation of cumulative state 1.19 will be updated accordingly. If a representation of cumulative state 1.19 is maintained in raster form, a new vector event will be converted to raster before the cumulative state 1.19 is updated. The representation of cumulative state 1.19 can then be sent as a frame of an output digital video signal 1.70 to one or more digital video output ports 1.15. The output digital video signal 1.70 is converted by the DSP 1.14, and then output as analog video signal 1.71 through an analog video output port 1.16. The video output continues to be generated, in near real time, as the presenter uses the WB, thus modifying the cumulative state 1.19. Note that since changes to the WB surface 1.03 may occur relatively infrequently compared to the frame rate of video output, the same frame may sometimes be sent many times before the cumulative state 1.19 is updated.

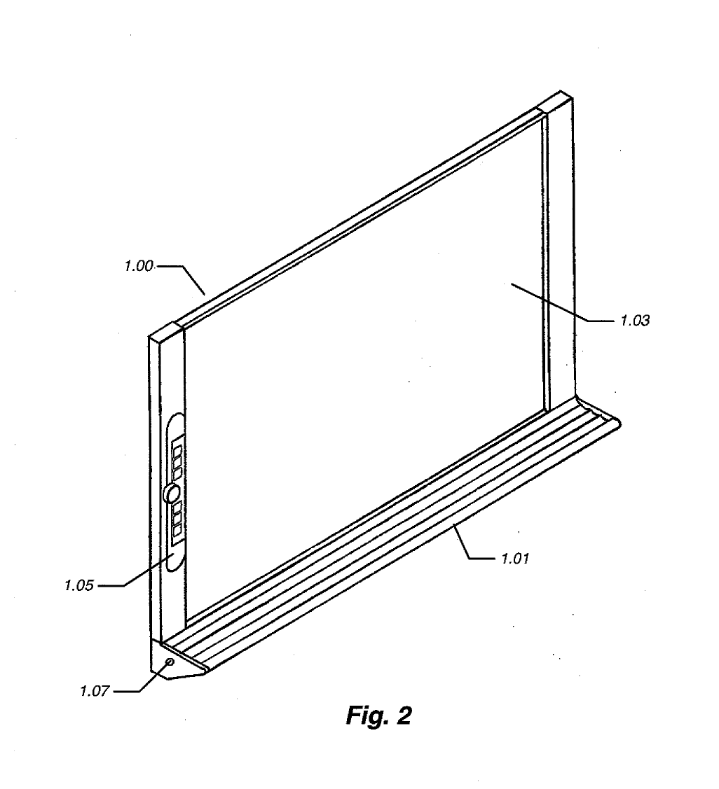

FIG. 2 is a perspective drawing of a WB Assembly 1.00, showing an exemplary WB surface 1.03, tray 1.01, WBUI 1.05, and WB HID Output Port 1.07. The WBUI 1.05 unit might also house the WBC 1.04.

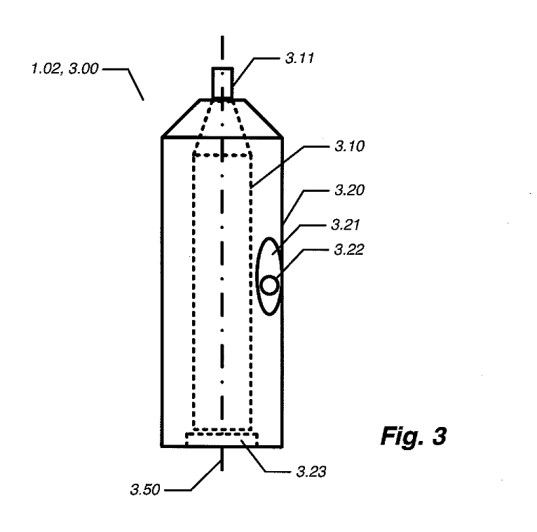

FIG. 3 (not to scale) shows a side view of a marker tool 3.00, such as might be used with the WB Assembly 1.00. Internal parts are shown with short dashes. The marker tool 3.00, which is essentially symmetrical around a longitudinal axis 3.50 includes a conventional marker 3.10 that contains no electronics, such as might be purchased off-the-shelf at a typical office supply store. (Of course, tools specialized to the system that come preassembled are also possible within the scope of the invention.) The conventional marker 3.10 has been inserted into a marker holder 3.20 that includes a sensor 3.21, a tool transmitter 3.22, and a tool receiver 3.23, whereby the marker tool 3.00 cooperates to allow the drawing detection manager 1.06 to detect status and activity information. In general, the marker holder 3.20 may contain zero or more sensors, transmitters, and receivers, in any combination, depending on how the drawing detection manager 1.06 performs detection of state and activities of the tool 1.02 in a particular embodiment of the invention. The transmitters and receivers might utilize air compression (sound or ultrasound) or electromagnetic radiation (light, infrared, or ultraviolet radiation), or any other form of wireless communications. One or a plurality of forms of communication methods might be used within a single tool 1.02 to facilitate the detection process.

The tip 3.11 of the conventional marker 3.10 protrudes from the marker holder 3.20, permitting the marker tool 3.00 to apply ink to the WB surface 1.03. A cap 3.30 secures the conventional marker 3.10 in place within the marker holder 3.20. A battery (not shown) is included in the marker holder 3.20 to power the electronics, when the marker holder 3.20 is powered on with a switch (not shown). Note that in other embodiments, the adapted drawing tool 1.02 might provide its own user interface to set its characteristics, such as color or marker width. Alternatively, a central facility, such as a WBUI 1.05, might be capable of setting a parameter uniformly for all adapted drawing tools 1.02 or for classes of drawing tools (see, for example, the size buttons for marker width shown in FIG. 10) or for individual adapted drawing tools 1.02, using a unique identifier for each.

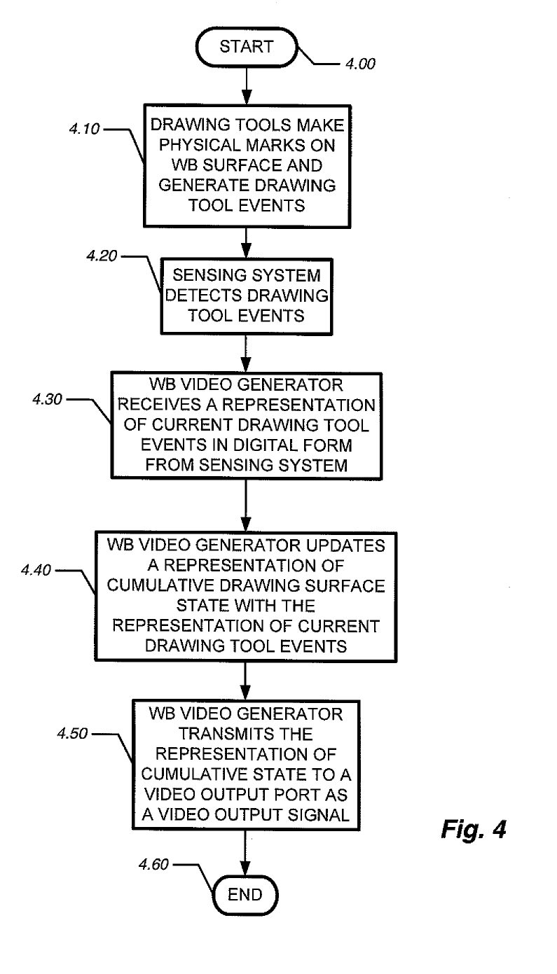

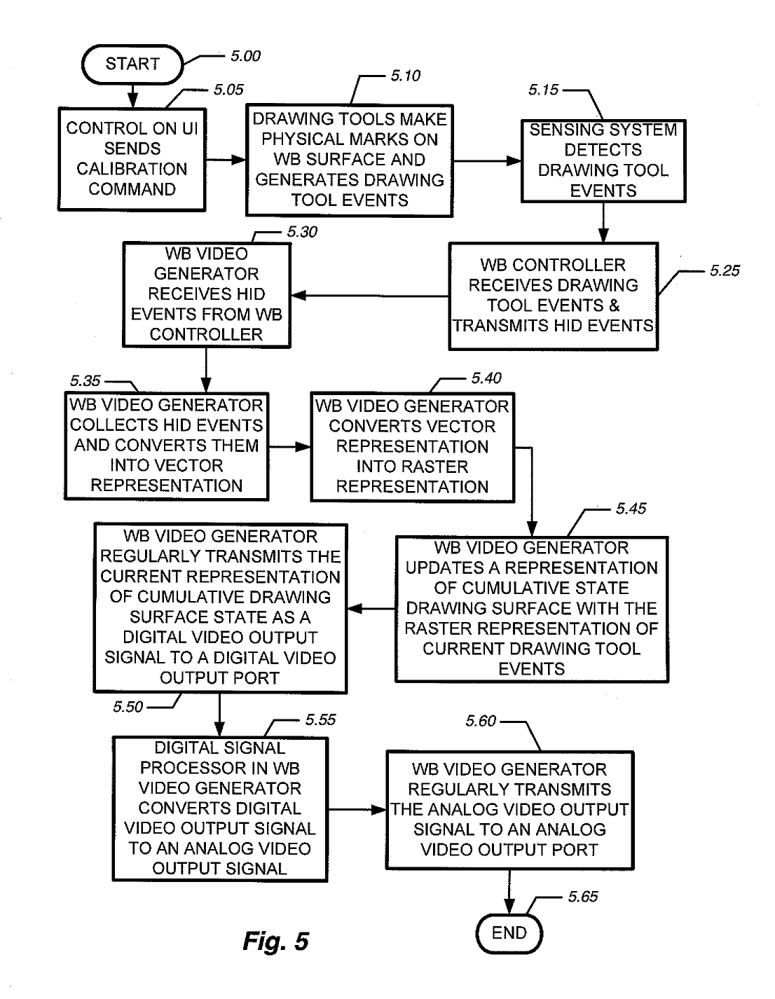

FIG. 4 is a flowchart showing a method for generating video signals from tool 1.02 events on the WB surface 1.03. After the start 4.00, adapted drawing tools 1.02 (being used by the presenter) make 4.10 physical marks on the WB surface 1.03. These marks might include, for example, strokes with a marker tool 3.00 or erasures with an eraser tool. The drawing detection manager 1.06 detects 4.20 drawing tool events, such as the color of the adapted drawing tool 1.02, marker up, marker down, and marker position. The WBVG 1.10 receives 4.30 a representation of current adapted drawing tool 1.02 events from the drawing detection manager 1.06. Receipt of this information might not be direct-there might be intermediate steps, as illustrated below by FIG. 5. The WBVG 1.10 updates 4.40 a representation of cumulative state 1.19 of the WB surface 1.03 with the current events. The updated cumulative state 1.19 is then transmitted 4.50 by the WBVG 1.10 to a video output port as a video output signal. The flow will continue until the system is shut down or a command to stop is given. An erase command will clear the cumulative state 1.19. The flow ends 4.60.

FIG. 5 is an elaboration of FIG. 4 for a class of more particular embodiments. After the flow start 5.00, a user-operable control on the WBUI 1.05 sends 5.05 a calibration command. This command may cause the system to power up; and/or the WBC 1.04 to determine the boundaries, position, or orientation of the WB surface 1.03. This command might be communicated to the WBVG 1.10, causing it to perform initialization steps. In step 5.10, adapted drawing tools 1.02 (being used by the presenter) make physical marks on the WB surface 1.03. A drawing detection manager 1.06 detects 5.15 drawing tool events, such as the color of the adapted drawing tool 1.02, marker up, marker down, and marker position. The drawing detection manager 1.06 may do this detection on its own, but more typically this will be done by some communication with the adapted drawing tool 1.02, as described previously. The WBC 1.04 receives 5.25 the drawing tool events from the drawing detection manager 1.06 and transmits them to the WBVG 1.10 as HID events. The WBVG 1.10 receives 5.30 the HID events. (Note that the functionality of the drawing detection manager 1.06 might actually be integrated into the WBC 1.04.) The WBVG 1.10 converts 5.35 HID events into a vector event representation. In some cases, it collects HID events. until it has a complete vector event, such as a marker stroke. However, in other situations, it may discontinue waiting, or time out, when further HID events are not received within some previously specified time interval. For example, a marker down event might be the start of a stroke, or it might indicate that a simple point was drawn. In the latter case, a time out could occur and the point might be treated as a complete vector event. The WBVG 1.10 then converts 5.40 the vector representation into a raster representation. The WBVG 1.10 uses the raster representation to update 5.45 a representation of cumulative state 1.19 of the WB surface 1.03 with the current adapted drawing tool 1.02 events. The cumulative state 1.19 is maintained from power on, or from the last erase command, whichever is more recent. The WBVG 1.10 regularly transmits 5.50 the cumulative state 1.19 as an output digital video signal 1.70 to a digital video output port 1.15. On an ongoing basis, the DSP 1.14 converts 5.55 the output digital video signal 1.70 to an output analog video signal 1.71; this is true even if the cumulative state 1.19 has not changed since the previous frame was sent so as to create video output in near real time. The WBVG 1.10 regularly transmits 5.60 the analog video signal 1.71 to an analog video output port 1.16. The flow will continue until the system is shut down or a command to stop is given. An erase command will clear the cumulative state 1.19. The flow ends 5.65.

The net result of the methods of FIG. 4 and FIG. 5 is that conventional adapted drawing tools 1.02 can be used on a conventional WB surface 1.03, the ongoing writings of a speaker being converted into video signal almost instantaneously. The video signal can be mixed with other video signal(s). It can be broadcast across a network, such as a local area network or a wide area network. It can be recorded for later viewing.

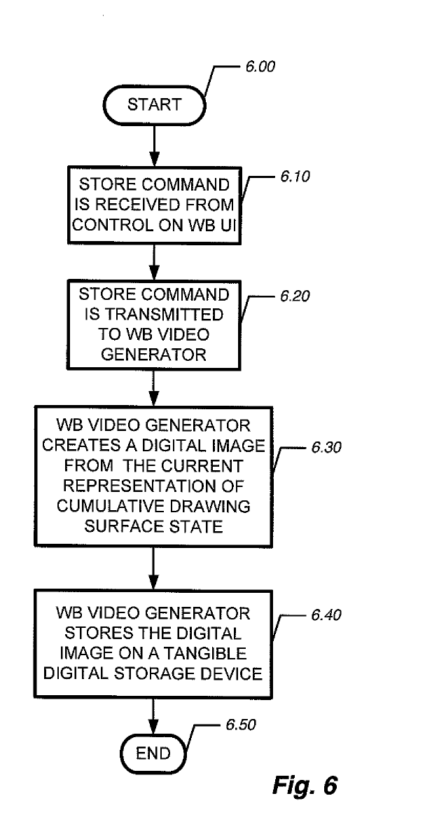

FIG. 6 is a flowchart showing a method for storing a snapshot of the current representation of the cumulative state 1.19 of the WB surface 1.03. For clarity, this flowchart omits repeating many of the details, shown in FIG. 4 or FIG. 5, which are not essential to understanding this method. After the start 6.00, a store command 6.10 is received by the WBC 1.04 from a user-operable control on the WBUI 1.05. The store command is transmitted 6.20 by the WBC 1.04 to the WBVG 1.10. The WBVG 1.10 creates 6.30 a digital image from the representation of cumulative state 1.19 of the WB surface 1.03. This digital image might be in any format, for example JPEG, TIFF, or GIF. The WBVG 1.10 stores 6.40 the digital image on a tangible digital storage device, such as an external storage device 1.30 (e.g., flash drive or disk drive) connected to the WBVG 1.10 through a external storage port 1.17. The flow ends 6.50.

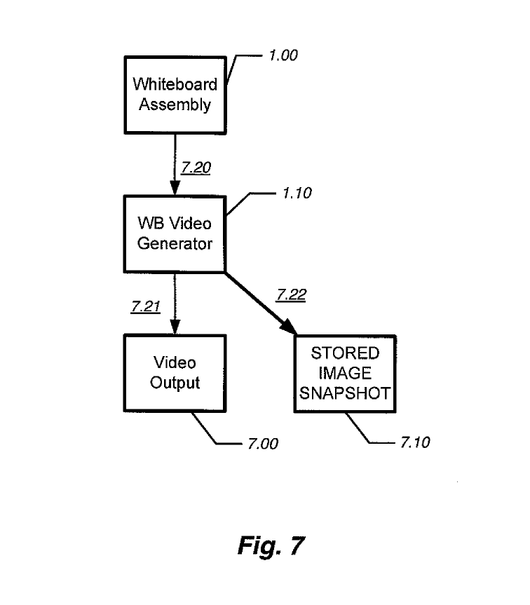

FIG. 7 is a simplified schematic diagram of a class of embodiments, showing information flows consistent with FIGS. 4-6. Information about drawing events on the WB surface 1.03 is transmitted 7.20 from the WB Assembly 1.00 to the WBVG 1.10. The WBVG 1.10 accumulates the cumulative state 1.19 of the WB surface 1.03, and regularly transmits 7.21 the cumulative state 1.19 as video output. The cumulative state 1.19 is updated as drawing events occur. A user command to the WBUI 1.05 can cause the cumulative state 1.19 to be stored 7.22 as a snapshot to an external storage device 1.30, such as a flash drive.

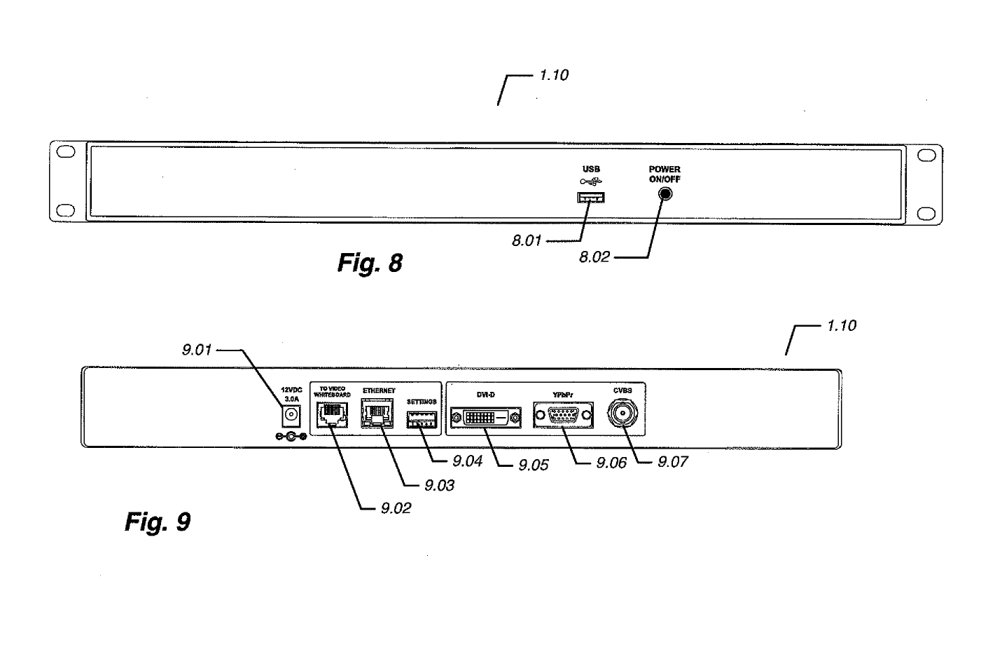

FIGS. 8 and 9 are front and rear views, respectively, of a WBVG 1.10 that is configured as an appliance. In other words, it is dedicated to converting current drawing tool events into representations of cumulative state 1.19 of the drawing surface, and transmitting such representations as at least one output video signal. Such a dedicated device may also store such representations in tangible digital storage and perform administrative tasks. But in any case, the device is intended not to be used as a general purpose computer. It does not have a keyboard or a mouse, and does not provide connectors that allow such user interaction devices to be connected to it. Dedication ensures consistent and reliable performance of the device, protects the device from infection and hacking, and reduces the cost to produce the device because it is simple, not to support functionality extraneous to its focused purposes.

The WBVG 1.10 in the embodiment shown has a power switch 8.02 and a USB port 8.01. The USB port 8.01 can be used to save cumulative state 1.19 to an external storage device 1.30, such as when a store command is given using the WBUI 1.05. The external storage device 1.30 might be a flash drive, a hard drive, a CD or DVD unit, or any other USB-compatible external storage device 1.30. The USB port can also be used to provide data and updates to the system, such as new versions of software. Note that the front panel only contains those features that a typical presenter would need to use. All other features and connectors are on the back panel.

The WBVG 1.10 includes a power supply jack 9.01. It includes a RJ45 jack 9.02 to connect the WBVG 1.10 to the WBC 1.04. In some embodiments, Ethernet cable connecting the two devices carries USB signal. The back panel includes another RJ45 jack 9.03 that allows the device to be connected to a network, which could be a local area network or a wide area network. Through this connection, various administrative tasks can be performed; for example, the system can be configured, software and firmware can be upgraded, and diagnostics can be performed. The WBVG 1.10 shown also has a set of dip switches 9.04 that allow further configuration. For example, analog output might be enabled or disabled, a particular model of WBC 1.04 or WBUI 1.05 might be chosen; or the WBVG 1.10 might be placed in/out of a diagnostic mode. The WBVG 1.10 shown has a DVI-D output jack 9.05, a digital video output port 1.15, and analog video output ports 1.16 including a YPbPr output jack 9.06 and a CVBS output jack 9.07.

FIG. 10 illustrates a detailed schematic diagram of a system, including a WB Assembly 1.00 and a WBVG 1.10. One-way information pathways in this figure are indicated by single arrows, typified by arrow 10.90; two-way pathways, by double arrows, typified by arrow 10.91. In addition to the WB surface 1.03 (not shown), the WBVG 1.10 includes a WBUI 1.05, adapted drawing tools 1.02, and various connections. The adapted drawing tools 1.02 include an eraser 1.02e, a black marker 1.02a, a red marker 1.02b, a blue marker 1.02c, and a green marker 1.02d. These colored markers might be configured as in FIG. 3. The WBUI 1.05 contain a calibrate button 10.01. Pressing this button turns on the WBUI 1.05 and WBC 1.04, and causes the system to determine various parameters about the geometry of the WB surface 1.03, including the locations of its boundaries. A clear button 10.02 instructs the WBVG 1.10 to clear its representation of cumulative state 1.19 of the WB surface 1.03. Note that it does not clear the physical WB surface 1.03, which must be done manually. A save button 10.03 instructs the WBVG 1.10 to save the current cumulative state 1.19 to external storage 1.30, here a USB flash drive. Three size buttons are included, size 1 button 10.04, size 2 button 10.05, and size 3 button 10.06. These select the marker width for subsequent marker usage.

This WBVG 1.10 includes a combined processor 10.26. The general purpose processor 1.12 and DSP 1.14 might be separate subprocessors, or cores within combined processor 10.26. Their functionality might also be handled as threads or processes within a single general purpose processor 1.12. The combined processor 10.26 has access to memory 1.18, here DDR2 SDRAM, where, for example it can hold software instructions, which are being executed, and data, including the cumulative state 1.19 of the WB surface 1.03. It has access to internal storage 1.13, here flash memory, where software programs and data can be saved. The WBVG 1.10 produces digital video output by regularly transmitting the current representation of cumulative state 1.19 of the WB surface 1.03, as occasionally updated by HID events from the WB Assembly 1.00; namely, DVI-D 10.34, through a DVI-D output jack 9.05 by way of RGBHV to DVI converter 10.25. The WBVG 1.10 also produces analog video output; namely, HD Component 10.33 through a YPbPr output jack 9.06 by way of YPbPr video amplifier 10.24, and SD Composite 10.32 through a CVBS output jack 9.07. The WBVG 1.10 includes a USB port 8.01 through which the cumulative state 1.19 can be saved to external storage 1.30, or from which system updates and data can be read. System configuration, diagnostics, updates, and other tasks can also be performed over 10/100 Ethernet 10.31 through RJ45 jack 9.03, to which combined processor 10.26 connects through Ethernet PHY 10.21, for example, through a local or wide area network. In some embodiments, video output may be transmitted through RJ45 jack 9.03.

The WBC 1.04 (not shown), here housed within the WBUI 1.05, outputs HID events through a USB-B device jack 10.10. The HID events are carried over USB cable 10.11 to USB-A host jack 10.12. Through the USB extender over CAT5 10.13, the medium for carrying the HID events and the USB signal is changed to CAT5, and made available through WB HID Output Port 1.07. The WB Assembly 1.00 communicates with the WBVG 1.10 using USB signal sent over CAT5 cable 10.30. As mentioned previously, the CAT5 cable 10.30 can carry the USB signal over a longer distance than USB cable. The CAT5 cable 10.30 connects to RJ45 jack 9.02 in the WBVG 1.10. The medium for carrying HID events is changed back to USB wiring standards by USB extender over CAT5 10.20. USB hub 10.22 serves USB port 8.01 and USB extender over CAT5 10.20.

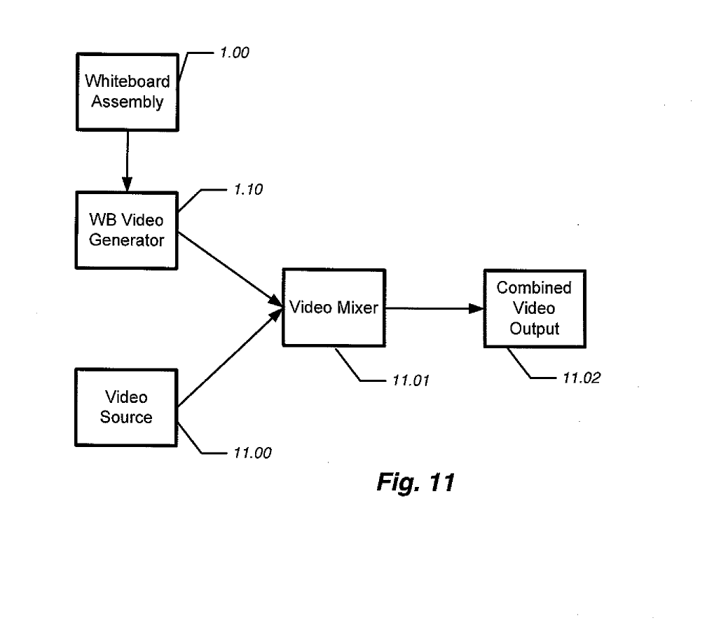

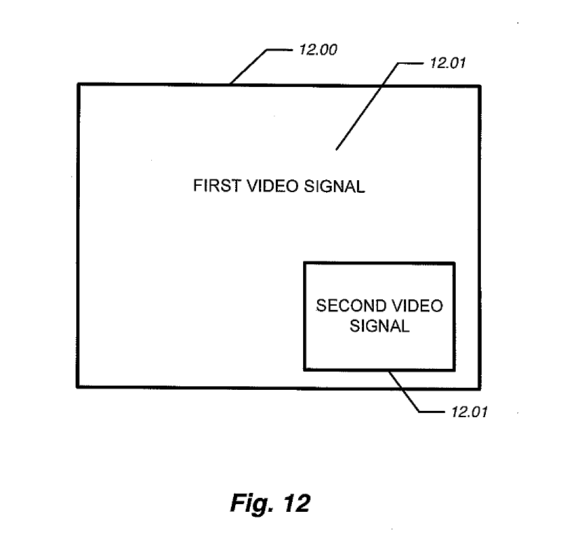

FIG. 11 shows how output from the WBVG 1.10 might be combined with output from another video source 11.00 to produce combined video output 11.02. A particular example scenario of such a combination is illustrated by FIG. 12. A lecture, carried over the Internet, is being presented on monitor 12.00 to an audience in a classroom in another city remote from the presentation. The rectangular monitor geometry is split into two windows, carrying a first video signal 12.01 and a second video signal 12.02, respectively. The first video signal 12.01 might be the video output from the WBVG 1.10. Unlike the video recording of the professor, this video output clearly shows the contents of the WB, free of shadows, reflections, and WB blemishes, and unobstructed by the body of the professor and the drawing tools. The second video signal 12.02 might be the video recording, which would show the professor's facial expressions and hand movements.

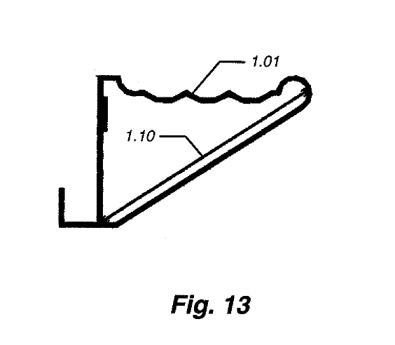

FIG. 13 is a cross section of a WB drawing tools tray 1.01. It shows how, in some embodiments of the invention, the WBVG 1.10 may be housed on a printed circuit board, entirely enclosed within the WB Assembly 1.00. In this case, the WB frame and/or tray 1.01 might have connections similar to those shown in FIG. 8 and FIG. 9.

Many variations of the above system and method are possible within the scope of the invention. For example, any communication links might be handled by wireless transmission. The present invention is, therefore, not limited to all the above details, as modifications and variations may be made without departing from the intent or scope of the invention. Consequently, the invention should be limited only by the following claims and equivalent constructions.

What is claimed is:

1. An apparatus, comprising:
a) a whiteboard assembly, having a drawing surface;
b) a drawing tool, whereby a plurality of drawing tool events make or remove physical marks on the drawing surface;
c) a drawing detection manager that detects the drawing tool events; and
d) a whiteboard video generator, which, on an ongoing basis,
(i) receives from the drawing detection manager a representation of current drawing tool events in a digital form,
(ii) updates a representation of cumulative state of the drawing surface by combining the representation of cumulative state with the representation of current drawing tool events,
(iii) regularly transmits the representation of cumulative state, in a first video signal to a first video output port, through which devices external to the apparatus can access the first video output signal.

2. The apparatus of claim 1, wherein the whiteboard video generator is an appliance that is dedicated to converting current drawing tool events into representations of cumulative state of the drawing surface, and transmitting those representations as at least one output video signal; provided, however, that the whiteboard video generator may also store such representations in tangible digital storage and perform administrative tasks.

3. The apparatus of claim 1, wherein the representation of cumulative state is maintained in memory.

4. The apparatus of claim 1, wherein the whiteboard video generator, on an ongoing basis, also
(iv) stores the representation of cumulative state in a tangible digital storage device.

5. The apparatus of claim 1, wherein the representation of cumulative state is maintained in raster form.

6. The apparatus of claim 1, wherein the representation of cumulative state is maintained in vector form.

7. The apparatus of claim 1, wherein drawing tool events include indication that the drawing tool has been applied to the drawing surface, indication that the drawing tool has been removed from the drawing surface, and indication of position of the drawing tool relative to boundaries of the drawing surface.

8. The apparatus of claim 7, wherein drawing tool events further include an indication of drawing tool color.

9. The apparatus of claim 1, wherein the drawing tool includes a sensor attached to a conventional marker or a conventional pen.

10. The apparatus of claim 9, wherein the drawing tool further includes a wireless transmitter from which the drawing detection manager receives a communication pertaining to state or activity of the drawing tool.

11. The apparatus of claim 9, wherein the drawing tool further includes a wireless receiver which receives a communication from the drawing detection manager.

12. The apparatus of claim 9, wherein the conventional marker or conventional pen is inserted into a sleeve, the sleeve containing the sensor.

13. The apparatus of claim 1, wherein the drawing tool is a conventional eraser to which the sensor is attached.

14. The apparatus of claim 1, wherein the first video output signal is a digital video output signal.

15. The apparatus of claim 14, wherein the whiteboard video generator also
(iv) regularly transmits the representation of cumulative state, in an analog video output signal, to an analog video output port, through which devices external to the apparatus can access the analog video output signal.

16. The apparatus of claim 1, the first video output signal is an analog video output signal.

17. The apparatus of claim 1, wherein the whiteboard video generator includes a digital signal processor (DSP), which converts the first video output signal, which is a digital video output signal, into an analog video output signal for output to an analog video output port.

18. The apparatus of claim 17, wherein the whiteboard video generator further includes a general purpose processor that updates the representation of cumulative state.

19. The apparatus of claim 1, further comprising:
e) a whiteboard controller that includes a user interface, the user interface having a user-operable control.

20. The apparatus of claim 19, wherein the control causes the whiteboard controller to sense locations of the boundaries of the whiteboard surface.

21. The apparatus of claim 19, wherein the control transmits a communication to the whiteboard video generator, the communication influencing how the whiteboard video generator computes the updated representation of cumulative state.

22. The apparatus of claim 21, wherein the communication sets the width of subsequent drawing tool events that represent strokes.

23. The apparatus of claim 21, wherein the communication sends an erase command that causes the representation of cumulative state of the drawing surface to be cleared.

24. The apparatus of claim 21, wherein the communication sends a store command that causes the cumulative state of the drawing surface to be stored in a user-removable tangible digital storage device.

25. The apparatus of claim 24, wherein the user-removable tangible digital storage device is connected to a USB port in the whiteboard video generator.

26. The apparatus of claim 1, further comprising:
e) a whiteboard controller, which, on an ongoing basis, receives data characterizing the user actions from the sensor wirelessly, and converts the data into HID events, which the whiteboard controller transmits to the whiteboard video generator as the representation of current drawing tool events.

27. The apparatus of claim 26, further comprising:
f) a USB cable through which the whiteboard controller transmits information directed to the whiteboard video generator;
g) a USB to CATS extension cable connecting the USB cable to a USB port in a whiteboard tray; and
h) a CATS cable connecting the USB port in the whiteboard tray to a USB port in the whiteboard video generator.

28. The apparatus of claim 26, wherein the whiteboard video generator, while updating the representation of cumulative state, converts the representation of a set of current drawing events into a stroke event in vector form.

29. The apparatus of claim 26, wherein the whiteboard video generator, while updating the representation of cumulative state, converts the stroke event into a digital raster representation.

30. The apparatus of claim 1, further comprising:
e) a video source;
f) a video mixer, connected to the first video output port and to the video source, that combines the first video output signal with a video output signal from the video source to create a combined video output signal, which the video mixer transmits to a video mixer output port.

31. The apparatus of claim 30, wherein, when combining the first video output signal with the video output signal from the video source, the video mixer superposes information represented in the first video output stream on the video output from the video source.

32. The apparatus of claim 1, wherein the whiteboard video generator is enclosed within a drawing tool tray that is included in the whiteboard assembly.

33. A method, comprising the steps of:
a) generating a plurality of drawing tool events by a drawing tool on a drawing surface of a whiteboard;
b) making or removing physical marks on the drawing surface while generating the plurality of drawing tool events;
c) detecting the drawing tool events by a drawing detection manager;
d) receiving, by a whiteboard video generator, from the drawing detection manager a representation of the current user drawing tool events in a digital form;
e) updating a representation of cumulative state of the drawing surface by combining the representation of cumulative state with the representation of current drawing tool events; and
f) regularly transmitting the representation of cumulative state, in a first video output signal, to a first video output port, through which devices external to the apparatus can access the first video output signal.

34. The method of claim 33, further comprising:
g) determining parameters of whiteboard geometry by calibration with a whiteboard controller.
